(19) United States
(12) Patent Application Publication
(10) Pub. No.: US 2018/0112128 A1
(43) Pub. Date: Apr. 26, 2018

(54) WAVELENGTH CONVERSION DEVICE, LIGHT SOURCE DEVICE, LIGHTING APPARATUS, AND PROJECTION IMAGE DISPLAY APPARATUS

(71) Applicant: PANASONIC INTELLECTUAL PROPERTY MANAGEMENT CO., LTD., Osaka (JP)

(72) Inventor: Kenta WATANABE, Osaka (JP)

(73) Assignee: PANASONIC INTELLECTUAL PROPERTY MANAGEMENT CO., LT D., Osaka (JP)

(21) Appl. No.: 15/786,980

(22) Filed: Oct. 18, 2017

(30) Foreign Application Priority Data
Oct. 25, 2016 (JP) 2016-208900

(51) Int. Cl. C09K 11/00; F21V 9/16; F21V 13/02; G03B 21/20; B32B 5/16

(52) U.S. Cl. CPC C09K 11/00; F21V 9/16; B32B 5/16; G03B 21/2006; F21V 13/02

(57) ABSTRACT

A wavelength conversion device includes: a substrate; and a phosphor layer on the substrate. The phosphor layer includes: a base material; phosphor particles which emit fluorescent light when excited by excitation light; and light transmissive particles each having a grain size that is within ±30% of a grain size of each of the phosphor particles, and a refractive index that is within ±7% of a refractive index of the base material.

### CROSS REFERENCE TO RELATED APPLICATION

This application claims the benefit of priority of Japanese Patent Application Number 2016-208900 filed on Oct. 25, 2016, the entire content of which is hereby incorporated by reference.

### BACKGROUND

### 1. Technical Field

The present disclosure relates to a wavelength conversion device which emits light when illuminated with excitation light, and a light source device, a lighting apparatus, and a projection image display apparatus which include the wavelength conversion device.

### 2. Description of the Related Art

In recent years, a light source device in which a solid-state light emitting element which emits laser light and a wavelength conversion component including phosphor particles are combined has been proposed. Japanese Unexamined Patent Application Publication No. 2013-254839 discloses a manufacturing method which uniformly disperses phosphor particles in a wavelength conversion component used in such a light source device.

### SUMMARY

In the meantime, when a phosphor layer contains a large amount of phosphor particles in a wavelength conversion device, a luminescent color (a hue of white light) of the wavelength conversion device varies to a great degree depending on a thickness of the phosphor layer that is formed. In other words, it is difficult to keep the luminescent color of the wavelength conversion device within a predetermined range.

The present disclosure provides a wavelength conversion device with which it is easy to keep a luminescent color within a predetermined range.

A wavelength conversion device according to an aspect of the present disclosure includes: a substrate; and a phosphor layer on the substrate. In the wavelength conversion device, the phosphor layer includes: a base material; phosphor particles which emit fluorescent light when excited by excitation light; and light transmissive particles each having a grain size that is within ±30% of a grain size of each of the phosphor particles, and a refractive index that is within ±7% of a refractive index of the base material.

A light source device according to an aspect of the present, disclosure includes the wavelength conversion device; and an excitation light source which emits the excitation light. The light source device emits white light including the excitation light and the fluorescent light emitted by the phosphor particles.

A lighting apparatus according to an aspect of the present disclosure includes the light source device and an optical component which collects or diffuses the white light emitted by the light source device.

A projection image display apparatus according to an aspect of the present disclosure includes: the light source device; an imaging element which modulates the white light emitted by the light source device, and outputs the modulated white light as an image; and a projection lens which projects the image output by the imaging element.

According to the present disclosure, it is possible to implement a wavelength conversion device with which it is easy to keep a luminescent color within a predetermined range.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is an external perspective view of the wavelength conversion device according to Embodiment 1;

FIG. 2 is a plan view of the wavelength conversion device according to Embodiment 1;

FIG. 3 is a schematic cross-sectional view taken along the line III-III of FIG. 2;

FIG. 4 is a schematic cress-sectional view of the wavelength conversion device according to a comparison example;

FIG. 5 is an external perspective view of the lighting apparatus according to Embodiment 2;

FIG. 6 is a schematic cross-sectional view illustrating a use mode of the lighting apparatus according to Embodiment 2;

FIG. 7 is an external perspective view of the projection image display apparatus according to Embodiment 3; and

FIG. 8 is a diagram which illustrates an optical system of the projection image display apparatus according to Embodiment 3.

### DETAILED DESCRIPTION OF THE EMBODIMENTS

Hereinafter, embodiments of the present disclosure are described with reference to the Drawings. It should be noted that the embodiment described below shows a general or specific example. The numerical values, shapes, materials, structural components, and the disposition and connection of the structural components, etc. described in the following embodiment are mere examples, and do not intend to limit the present disclosure. Furthermore, among the structural elements in the following exemplary embodiments, structural elements not recited in any one of the independent claims are described as arbitrary structural elements.

In addition, each of the diagrams is a schematic diagram and thus is not necessarily strictly illustrated. In each of the diagrams, substantially the same structural components are assigned with the same reference signs, and there are instances where redundant descriptions are omitted or simplified.

In addition, there are instances where coordinate axes are indicated in the diagrams used in describing the following embodiments. The z-axis direction of the coordinate axes is a vertical direction, for example, and the positive side of the Z-axis is indicated as an upper side (upward) and the minus side of the Z-axis is indicated as an lower side (downward). The Z-axis direction is, stated differently, a direction perpendicular to a substrate included in the wavelength conversion device. Furthermore, the X-axis direction and the Y-axis direction are orthogonal to each other on a plane (horizontal plane) perpendicular to the Z-axis direction. The X-Y plane is a plane parallel to a main surface of the substrate included in the wavelength conversion device. For example, in the following embodiments, the term “in a plan view” indicates to view in the Z-axis direction.

### Embodiment 1

(Configuration of Wavelength Conversion Device)

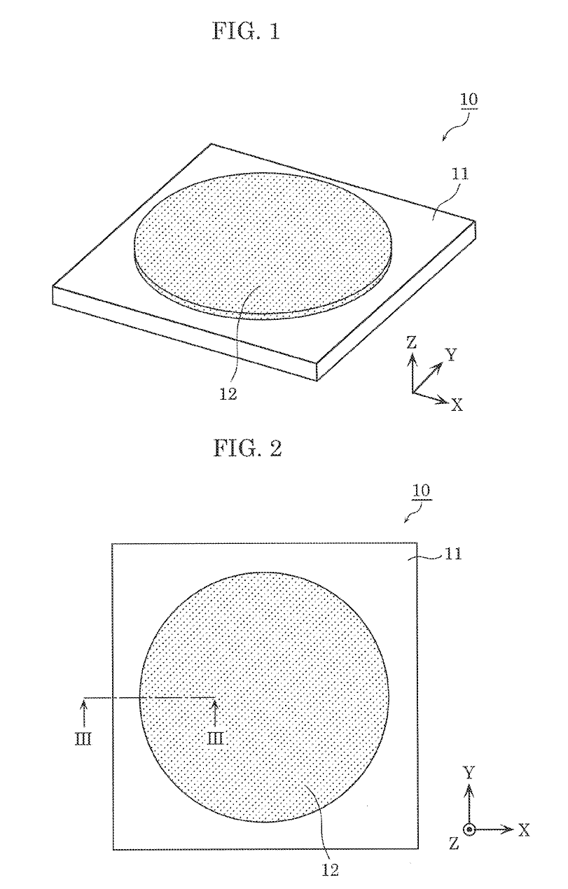

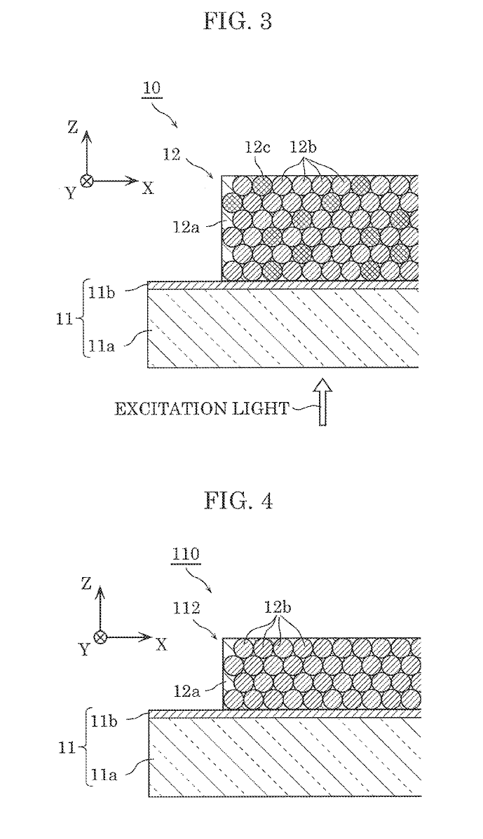

First, a configuration of the wavelength conversion device according to Embodiment 1 shall be described with reference to the drawings. FIG. 1 is an external perspective view of the wavelength conversion device according to Embodiment 1. FIG. 2 is a plan view of the wavelength conversion device according to Embodiment 1. FIG. 3 is a schematic cross-sectional view taken along the line III-III of FIG. 2. It should be noted that, in FIG. 3, there are instances where a magnitude correlation of the thickness between structural components, for example, is not accurately described.

As illustrated in FIG. 1 to FIG. 3, wavelength conversion device 10 according to Embodiment 1 includes substrate 11 and phosphor layer 12,

Wavelength conversion device 10 is a device which emits fluorescent light when excited by excitation light. More specifically, wavelength conversion device 10 includes substrate 11 and phosphor layer 12, and phosphor particles 12b contained in phosphor layer 12 are excited by excitation light to emit fluorescent light. Wavelength conversion device 10 is, stated differently, a light transmissive phosphor plate which converts a wavelength of a portion of blue laser light (excitation light) emitted by a laser light source, into a wavelength of yellow fluorescent light, and emits the yellow fluorescent light. Wavelength conversion device 10 emits white light including blue laser light which passes through phosphor layer 12 and the yellow fluorescent light emitted by phosphor particles 12b. It should be noted that wavelength conversion device 10 may be a reflective phosphor plate, or may be a phosphor wheel used in a projection image display apparatus.

Substrate 11 is a light transmissive substrate. More specifically, substrate 11 includes substrate body 11a and dichroic mirror layer 11b.

Substrate body 11a is a plate component having a rectangular shape in a plan view. Dichroic mirror layer 11b is disposed on a first main surface of substrate body 11a on the positive side of the Z-axis. Substrate body 11a has a second main surface on the negative side of the Z-axis which is an incident surface of excitation light. Substrate body 11a is, specifically, a sapphire substrate. Substrate body 11a may be any other light transmissive substrate, such as a light transmissive ceramic substrate formed using polycrystal alumina or aluminum nitride, a transparent glass substrate, a quartz substrate, or a transparent resin substrate. In the case where wavelength conversion device 10 is a reflective phosphor plate, for example, substrate body 11a may be a substrate which is not light transmissive. In addition, substrate body 11a may have any other shape in a plan view, such as a circular shape.

Dichroic mirror layer 11b is a thin film having a property which transmits light of a blue wavelength region, and reflects light of a yellow wavelength region. More specifically, dichroic mirror layer 11b has a property that transmits excitation light emitted by the laser light source, and reflects fluorescent light emitted by phosphor layer 12. With dichroic mirror layer 11b, it is possible to increase light emitting efficiency of wavelength conversion device 10.

Phosphor layer 12 is disposed on substrate 11 (i.e., on dichroic mirror layer 11b). Although phosphor layer 12 has a circular shape in a plan view (a shape viewed in the direction perpendicular to the Z-axis), phosphor layer 12 may have any other shape such as a rectangular shape or an annular shape. Phosphor layer 12 includes base material 12a, phosphor particles 12b, and light transmissive particles 12c. Phosphor layer 12 is formed by printing, on substrate 11, a paste formed using base material 12a including phosphor particles 12b and light transmissive particles 12c, for example. Phosphor layer 12 has a thickness that is, for example, at least 60 pm and at most 100 μm.

Base material 12a is formed using an inorganic material such as glass, or using an organic-inorganic hybrid material. As described above, since base material 12a includes an inorganic material, it is possible to increase a heat dissipation performance of wavelength conversion device 10. An optical refractive index (hereinafter simply described as a refractive index) of base material 12a is, for example, at least 1.4 and at most 1.5. The refractive index of base material 12a is lower than a refractive index of phosphor particles 12b.

Phosphor particles 12b are dispersedly disposed in phosphor layer 12 (base material 12a), and emits light when excited by blue laser light emitted by the laser light source. In other words, phosphor particles 12b emit fluorescent light when excited by excitation light. Phosphor particles 12b are, specifically, yttrium-aluminum-garnet (VAG) yellow phosphor particles which emit yellow fluorescent, light. It should be noted that phosphor layer 12 may include, as phosphor particles 12h, green phosphor particles such as Lu₃Al₅O₁₂:Ce³⁺ phosphor, instead of the yellow phosphor particles or in addition to the yellow phosphor particles. Furthermore, phosphor layer 12 may include, as phosphor particles 12b, red phosphor particles such as CaAlSiN₃:Eu²⁺ phosphor or (Sr, Ca)AlSiN₃:Eu²+ phosphor, in addition to the yellow phosphor particles. As described above, phosphor particles 12b included in phosphor layer 12 are not specifically limited.

Phosphor particles 12b each have a grain size that is, for example, at least 5μm and at most 20μm. The grain size is, more specifically, a median size (d50) or a mean diameter. The same applies hereafter. In addition, phosphor particles 12b each have an optical refractive index that is, for example, at least 1.7 and at most 1.9.

(Light Transmissive Particle)

Light transmissive particles 12c are transparent particles or particles that are light transmissive, and dispersedly disposed in phosphor layer 12 (base material 12a). In other words, light transmissive particles 12c transmits excitation light emitted by the laser light source. In addition, unlike phosphor particles 12b, light transmissive particles 12c are not excited by excitation light. This means that light transmissive particles 12c do not emit fluorescent light.

Light transmissive particles 12c each have a grain size substantially equivalent to the grain size of each of phosphor particles 12b. The grain size is, more specifically, a median size (d50) or a mean diameter. The same applies hereafter. The grain size of each of light transmissive particles 12c is, for example, within ±30% of the grain size of each of phosphor particles 12b; that is, at least 70% and at most 130% of the grain size of each of phosphor particles 12b. The grain size of each of light transmissive particles 12c is, for example, at least 5 μm and at most 20 μm.

In addition, each of light transmissive particles 12c has a refractive index substantially equivalent to the refractive index of base material 12a. The refractive index of each of light transmissive particles 12c is, for example, within ±7% of the refractive index of base material 12a; that is, at least 93% and at most 107% of the refractive index of base material 12a. The refractive index of each of light transmissive particles 12c is lower than the refractive index of each of phosphor particles 12b. Light transmissive particles 12c are each, specifically, silica or zinc oxide. However, these are non-limiting examples. Light transmissive particles 12c may be formed using the same material as base material 12a, or may be formed using a material different from the material of base material 12a.

The following describes advantageous effects obtained by light transmissive particles 12c with reference to a wavelength conversion device according to a comparison example. FIG. 4 is a schematic cross-sectional view of the wavelength conversion device according to a comparison example.

As illustrated in FIG. 4, phosphor layer 112 included in wavelength conversion device 110 according to the comparison example does not include light transmissive particles 12c, and includes phosphor particles 12b which are densely arranged. Most of phosphor particles 12b included in phosphor layer 12 are directly in contact with other phosphor particles 12b. In particular, in wavelength conversion device 110 which emits light using laser light (blue laser light) as excitation light, phosphor particles 12b are densely arranged in order to increase heat dissipation performance of phosphor particles 12b, and one phosphor particle 121) conducts heat to substrate 11 via other phosphor particles 12b in contact with the one phosphor particle 12b.

Since the amount of phosphor particles 12b included per unit volume is large in phosphor layer 12, the luminescent color (a hue of white light) of wavelength conversion device 110 varies to a great degree in the case where the thickness of phosphor layer 112 varies when forming phosphor layer 112 or substrate 11. Accordingly, in manufacturing wavelength conversion device 110, it is necessary to severely control the thickness of phosphor layer 112 in order to keep the luminescent color of wavelength conversion device 110 in a predetermined range. This means that there is a problem that phosphor layer 112 is not easily manufactured. The thickness of phosphor layer 112 is approximately 4 μm, for example.

To address such a problem, a method of decreasing the density of phosphor particles 12b in phosphor layer 112 is conceivable. However, with such a method, a gap is generated between phosphor particles 12b, and thus the above-described thermal conductivity to substrate 11; that is, the heat dissipation performance of phosphor particles 12b is deteriorated.

Accordingly, phosphor layer 12 included in wavelength conversion: device 10 includes light transmissive particles 12c. Since phosphor layer 12 includes light transmissive particles 12c, the amount of phosphor particles 12b per unit volume included in phosphor layer 12 is less than the amount of phosphor particles 12b per unit volume included in phosphor layer 112.

Accordingly, even when the thickness of phosphor layer 12 varies among a plurality of wavelength conversion devices 10 in the manufacturing process, it is possible to suppress variation in the luminescent color among the plurality of wavelength conversion devices 10. For that reason, it is possible to more easily keep the luminescent color within a predetermined range in manufacturing wavelength conversion device 10, compared to manufacturing of wavelength conversion device 110.

It should be noted that, according to a result of earnest investigation by the inventors, phosphor layer 12 may contain light transmissive particles 12c in a volume of at, least 20% relative to phosphor particles 12b. With this configuration, it is possible to sufficiently suppress variation in the luminescent color of wavelength conversion device 10, which occurs due to variation in the thickness of phosphor layer 12.

In addition, phosphor layer 12 includes light transmissive particles 12c which partially replace phosphor particles 12b included in phosphor layer 112. Accordingly, most of phosphor particles 12b included in phosphor layer 12 are directly in contact with other phosphor particles 12b or light transmissive particles 12c. As described above, since the densely-arranged state of particles (phosphor particles 12b and light transmissive particles 12c) is maintained in wavelength conversion device 10, deterioration in the heat dissipation performance is suppressed.

It should be noted that, according to a result of earnest investigation by the inventors, phosphor layer 12 may contain phosphor particles 12b and light transmissive particles 12c in a total volume of at least 45% relative to base material 12a. This makes it easy to densely arrange the particles in phosphor layer 12.

In addition, since phosphor layer 12 includes light transmissive particles 12c which partially replace phosphor particles 12b included in phosphor layer 112, there is an advantageous effect that the method of manufacturing phosphor layer 112 can be applied substantially as it is to the method of manufacturing phosphor layer 12. It should be noted that phosphor layer 12 has less contained amount of phosphor particles 12b than phosphor layer 112. For that reason, when white light of the same color is emitted by each of wavelength conversion device 10 and wavelength conversion device 110, the thickness of phosphor layer 12 is larger than the thickness of phosphor layer 112. As described, above, phosphor layer 12 has a thickness that is, for example, at least 60 μm and at most 100 μm.

In the meantime, although an organic material such as a silicone resin is generally used as base material 12a in a wavelength conversion device which uses light emitting diode (LED) light as excitation light, an inorganic material such as glass or an organic-inorganic hybrid material is used as base material 12a in wavelength conversion device 10 which uses laser light as excitation light.

With this configuration, the heat dissipation performance of phosphor particles 12b is enhanced. Meanwhile, the inorganic material such as glass has a refractive index higher than a refractive index of the organic material such as a silicone resin. For that reason, a light extraction efficiency of wavelength conversion device 10 is lower than a light extraction efficiency of a wavelength conversion device which uses LED light as excitation light.

Here, wavelength conversion device 10 includes, in place of phosphor particles 12b, light transmissive particles 12c each having a refractive index lower than a refractive index of each of phosphor particles 12b. For that reason, the light extraction efficiency of wavelength conversion device 10 is enhanced compared to the light extraction efficiency of wavelength conversion device 110.

(Advantageous Effects, etc.)

As described above, wavelength conversion device 10 includes substrate 11 and phosphor layer 12 disposed on substrate 11. Phosphor layer 12 includes base material 12a, phosphor particles 12b which emit fluorescent light when excited by excitation light, and light transmissive particles 12c each having a grain size that is within ±30% of a grain size of each of phosphor particles 12b and having a refractive index within ±7% of a refractive index of base material 12a.

With this configuration, the amount of phosphor particles 12b per unit volume in phosphor layer 12 is decreased, and thus variation in the luminescent color due to variation in the thickness of phosphor layer is suppressed. Accordingly, with wavelength conversion device 10, the luminescent color is easily kept within a predetermined range.

Phosphor layer 12 may contain phosphor particles 12b and light transmissive particles 12c in a volume of at least 45% relative to the base material.

This makes it easy to densely arrange the particles in phosphor layer 12.

In addition, phosphor layer 12 may contain light transmissive particles 12c in a volume of at least 20% relative to phosphor particles 12b.

With this configuration, it is possible to sufficiently suppress variation in the luminescent color of wavelength conversion device 10, which occurs due to variation in the thickness of phosphor layer 12.

In addition, the grain size of each of phosphor particles 12b and the grain size of each of light transmissive particles 12c may be each at least 5 μm and at most 20 μm.

As described above, when the grain size of each of light transmissive particles 12c is within a range assumable as the grain size of each of phosphor particles 12b, it is possible to apply the method of manufacturing wavelength conversion device 110 which does not include light, transmissive particles 12c substantially as it is, to wavelength conversion device 10.

### Embodiment 2

(Overall Configuration)

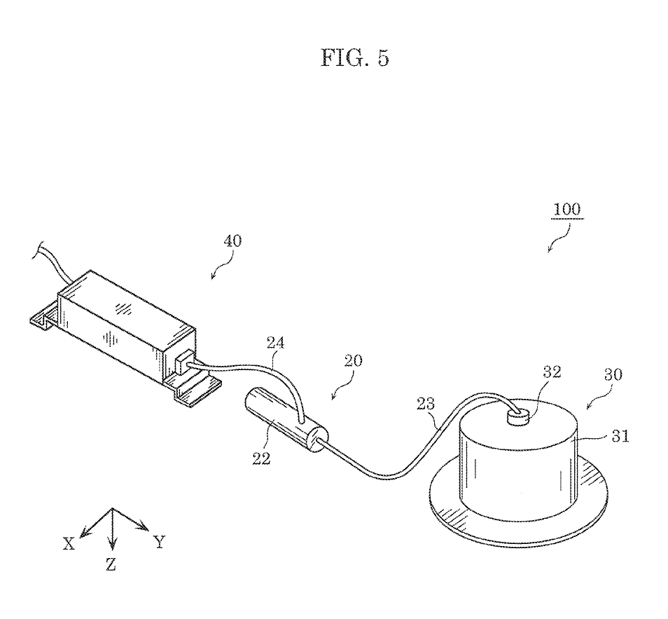

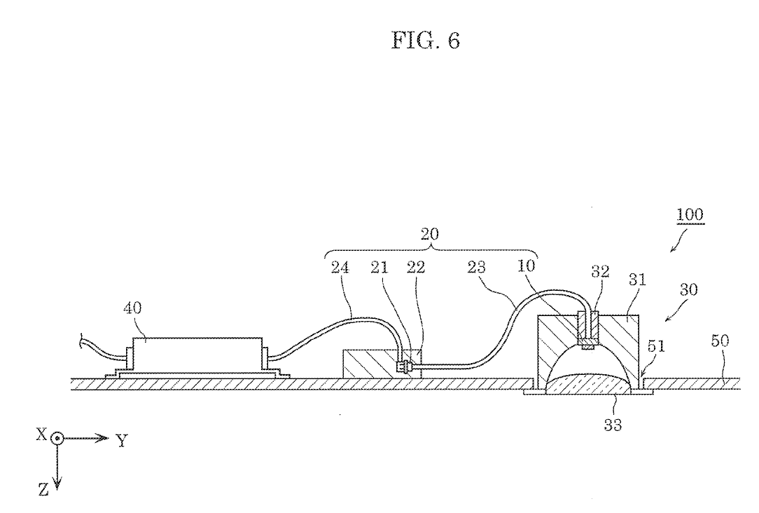

In Embodiment 2, a light source device including wavelength conversion device 10, and a lighting apparatus including the light source device will be described. FIG. 5 is an external perspective diagram of the lighting apparatus according to Embodiment 2. FIG. 6 is a schematic cross-sectional view illustrating a use mode of the lighting apparatus according to Embodiment 2. It should be noted that, in FIG. 6, only the illustration of power supply device 40 shows a side surface instead of a cross-section surface.

As illustrated in FIG. 5 and FIG. 6, lighting apparatus 100 is a downlight attached to ceiling 50 of a building. Lighting apparatus 100 includes light source device 20, lighting device 30, and power supply device 40. Light source device 20 and lighting device 30 are optically connected via optical fiber 23. Light source device 20 and power supply device 40 are electrically connected via power supply cable 24.

Lighting apparatus 100 is mounted on ceiling 50 in a state in which lighting device 30 is inserted into opening 51 of ceiling 50. In other words, lighting apparatus 100 is disposed on a back surface of the ceiling except a portion of lighting device 30.

(Light Source Device)

Next, light source device 20 will be described in detail. Light source device 20 includes laser light source 21 which emits blue laser light and wavelength conversion device 10. Light source device 20 emits white light with the combination of laser light source 21 and wavelength conversion device 10. More specifically, source device 20 emits white light including excitation light (blue laser light) and fluorescent light emitted by phosphor particles 12b. Light source device 20 includes laser light source 21, heat sink 22, optical fiber 23, power supply cable 24, and wavelength conversion device 10.

Laser light source 21 is an example of an excitation light source which emits excitation light. Laser light source 21 is, for example, a semiconductor laser which emits blue laser light. The center emission wavelength of laser light source 21 is, for example, at least 440 nm and at most 470 nm. Laser light source 21 may emit blue-violet light or ultraviolet light. Laser light source 21 is specifically a CAN package element. However, laser light source 21 may be a chip type element.

Heat sink 22 is a structure used for dissipating heat of laser light source 21 that is currently emitting light. Heat sink 22 houses laser light source 21 therein, and also functions as an outer casing of light source device 20. Heat sink 22 is capable of dissipating heat generated in laser light source 21. Heat sink 22 is formed using, for example, metal that is relatively high in thermal conductivity, such as aluminum or copper.

Optical fiber 23 guides laser light emitted by laser light source 21 to the outside of heat sink 22. Optical fiber 23 includes an entrance located inside heat sink 22. The laser light emitted by laser light source 21 enters the entrance of optical fiber 23. Optical fiber 23 includes an exit located inside lighting device 30. The laser light that exits through the exit is emitted to wavelength conversion device 10 located inside lighting device 30.

Power supply cable 24 is a cable for supplying, to light source device 20, power supplied from power supply device 40. Power supply cable 24 has one end connected to a power supply circuit in power supply device 40, and the other end connected to laser light source 21 through an opening defined in heat sink 22.

(Lighting Device)

The following describes lighting device 30. Lighting device 30 is fitted to Opening 51, and converts a wavelength of laser light guided by optical fiber 23 to emit light of a predetermined color. Lighting device 30 includes casing 31, holder 32, and lens 33.

Casing 31 is a cylindrical component having an open end on the positive side of the Z-axis and a closed-end on the opposite side, and houses holder 32, wavelength conversion device 10, and lens 33. The outer diameter of casing 31 is slightly smaller than the diameter of opening 51, and casing 31 is fitted to opening 51. Casing 31 is, more specifically, fixed to opening 51 using an attachment spring (not illustrated). Casing 31 is, for example, formed using metal that is relatively high in thermal conductivity, such as aluminum or copper.

Holder 32 is a cylindrical component which holds optical fiber 23, and includes a portion that is housed in casing 31. Holder 32 is disposed on an upper portion of casing 31. Optical fiber 23 is held in a state in which optical fiber 23 is passed through a through hole along the center axis of holder 32. Holder 32 holds optical fiber 23 in such a manner that the exit of optical fiber 23 faces the positive side of the Z-axis (the side on which wavelength conversion device 10 is present). Holder 32 is formed using, for example, aluminum, copper, or the like. However, holder 32 may be formed using resin.

Lens 33 is an optical component which is disposed on an exit of casing 31, and controls distribution of light emitted by wavelength conversion device 10. Lens 33 is an example of the optical component which collects or diffuses white light emitted by light source device 20 (wavelength conversion device 10). Lens 33 has a surface which faces wavelength conversion device 10, and has a shape that enables taking light emitted by wavelength conversion device 10 into lens 33 without leakage as much as possible.

(Power Supply Device)

Next, power supply device 40 will be described. Power supply device 40 is a device which supplies power to light source device 20 (laser light source 21). Power supply device 40 houses a power supply circuit therein. The power supply circuit generates power for causing light source device 20 to emit light, and supplies the generated power to lighting device 30 via power supply cable 24. The power supply circuit is, specifically, an AC/DC converter circuit which converts AC power supplied from a power system to DC power, and outputs the DC power. Accordingly, DC current is supplied to laser light source 21.

### Advantageous effects etc of Embodiment 2

As described above, light source device 20 includes wavelength conversion device 10 and laser light source 21 which emits excitation light. Light source device 20 emits white light including excitation light and fluorescent light emitted by phosphor particles 12b. Laser light source 21 is an example of an excitation light source.

With light source device 20 described above, the luminescent color is easily kept within a predetermined range.

Lighting apparatus 100 includes light source device 20 and lens 33 which collects or diffuses white light emitted by light source device 20. Lens 33 is an example of the optical component.

With lighting apparatus 100 described above, the luminescent color is easily kept within a predetermined range.

### Embodiment 3

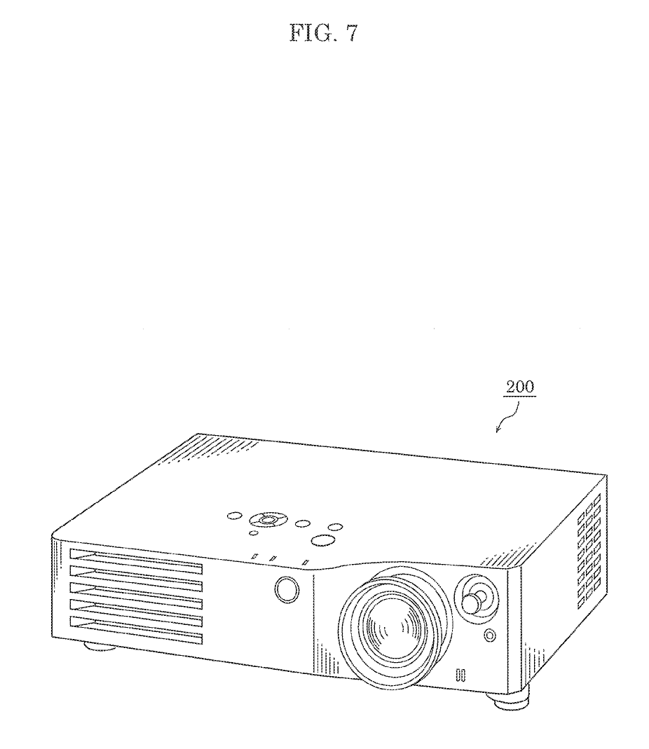

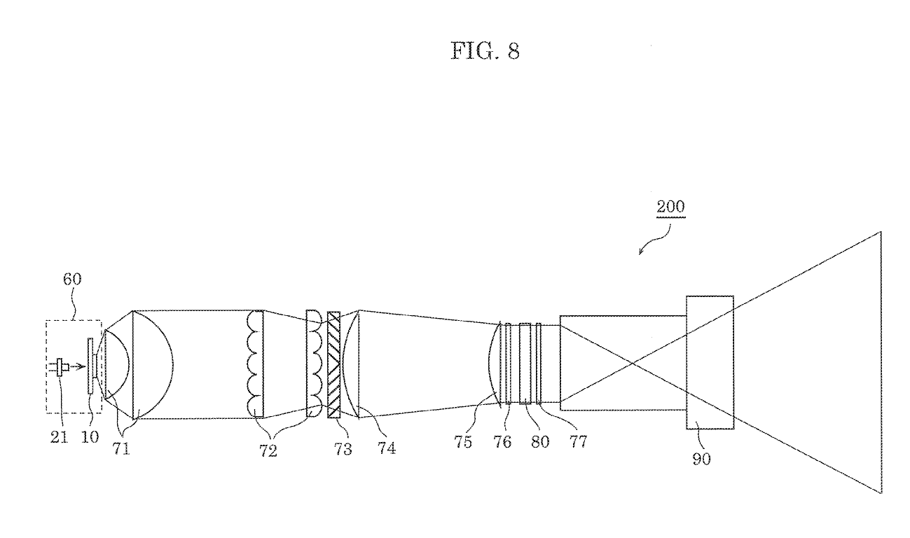

In Embodiment 3, a light source device including wavelength conversion device 10, and a projection image display apparatus including the light source device will be described. FIG. 7 is an external perspective view of the projection image display apparatus according to Embodiment 3. FIG. 8 is a diagram which illustrates an optical system of the projection image display apparatus according to Embodiment 3.

As illustrated in FIG. 7 and FIG. 8, projection image display apparatus 200 is a single plate projector. Projection image display apparatus 200 includes light source device 60, collimate lens 71, integrator lens 72, polarized beam splitter 73, condenser lens 74, and collimate lens 75. In addition, projection image display apparatus 200 includes entrance-side polarization element 76, imaging element 80, exit-side polarization element 77, and projection lens 90.

Light source device 10 emits white light including excitation light (blue laser light) and fluorescent light emitted by phosphor particles 12b. Light source device 60 includes, specifically, laser light source 21 and wavelength conversion device 10.

White light emitted by light source device 60 is collimated by collimate lens 71, and integrator lens 72 homogenizes an intensity distribution. The light whose intensity distribution is homogenized is converted to linearly polarized light, by polarized beam splitter 73. Here, the light whose intensity distribution is homogenized is, for example, converted to light of P polarization.

The light converted to the light of P polarization is incident on condenser lens 74, further collimated by collimate lens 75, and incident on. entrance-side polarization element 76.

Entrance-side polarization element 76 is a polarization plate (polarization control element) which polarizes incident light toward imaging element 80. Exit-side polarization element 77 is a polarization plate which polarizes light that exits imaging element 80. Imaging element 80 is disposed between entrance-side polarization element 76 and exit-side polarization element 77.

Imaging element 80 is a substantially planar element which spatially modulates white light emitted by light source device 60, and outputs the spatially modulated white light as an image. Imaging element 80, stated. differently, generates light for an image. Imaging element 80 is, specifically, a transmissive liquid crystal panel.

Since a polarization control region of entrance-side polarization element 76 transmits light of P polarization, light incident on entrance-side polarization element 76 enters imaging element 80, is modulated by imaging element 80, and exits imaging element 80. In addition, unlike entrance-side polarization element 76, exit-side polarization element 77 transmits only light of S polarization. Accordingly, only components of the light of S polarization. included in the modulated light pass the polarization control region of exit-side polarization element 77, and are incident on projection lens 90.

Projection lens 90 projects an image output by imaging element 80. As a result, an image is projected on a screen or the like.

### Advantageous Effects, etc., of Embodiment 3

As described above, projection image display apparatus 200 includes light source device 60, imaging element 80 which modulates white light emitted by light source device 60 and outputs the modulated white light as an image, and projection lens 90 which projects the image output by imaging element 80.

With lighting apparatus 200 described above, luminescent color is easily kept within a predetermined range.

It should be noted that the optical system of projection image display apparatus 200 described in Embodiment 3 is an example. Imaging element 80, for example, may be a reflective imaging element such as a digital micromirror device (DMD) or a reflective liquid crystal panel. In addition, a three-plate optical system may be used in projection image display apparatus 200,

### Other Embodiments

Although Embodiments 1 to 3 have been described thus far, the present disclosure is not limited to the above-described embodiments.

For example, although the laser light source has been described as a semiconductor laser in the above-described embodiments, the laser light source may be a laser other than the semiconductor laser. The laser light source may be, for example, solid-state laser such as YAG laser, liquid laser such as pigment laser, or gas laser such as Ar ion laser, He—Cd laser, nitrogen laser, or excimer laser. In addition, the light source device may include a plurality of laser light sources. Furthermore, the light source device may include a solid-state light emitting element other than the semiconductor laser, such as an LED light source, an organic electro luminescence (EL) element, or an inorganic EL element, as the excitation light source.

It should be noted that the present disclosure also includes other forms in winch various modifications apparent to those skilled in the art are applied to the embodiments or forms in which structural elements and functions in the embodiments, modifications, and examples are arbitrarily combined within the scope of the present disclosure.

While the foregoing has described one or more embodiments and/or other examples, it is understood that various modifications may be made therein arid that the subject matter disclosed herein may be implemented in various forms and examples, and that they may be applied in numerous applications, only some of which have been described herein. It is intended by the following claims to claim any and all modifications and variations that fall. within the true scope of the present teachings.

What is claimed is:

1. A wavelength conversion device, comprising:
a substrate; and
a phosphor layer on the substrate,
wherein the phosphor layer includes;
a base material;
phosphor particles which emit fluorescent light when excited by excitation light; and
light transmissive particles each having a grain size that is within ±30% of a grain size of each of the phosphor particles, and a refractive index that is within ±7% of a refractive index of the base material.

2. The wavelength conversion device according to claim 1,
wherein the phosphor layer contains the phosphor particles and the light transmissive particles in a volume of at least 45% relative to the base material.

3. The wavelength conversion device according to claim 1,
wherein the phosphor layer contains the light transmissive particles in a volume of at least 20% relative to the phosphor particles.

4. The wavelength conversion device according to claim 1,
wherein the grain size of each of the phosphor particles and the grain size of each of the light transmissive particles are each at least 5 μm and at most 20 μm.

5. A light source device, comprising:
the wavelength conversion device according to claim 1; and
an excitation light source which emits the excitation light,
wherein the light source device emits white light including the excitation light and the fluorescent light emitted by the phosphor particles.

6. A lighting apparatus, comprising:
the light source device according to claim 5; and
an optical component which collects or diffuses the white light emitted by the light source device.

7. A projection image display apparatus, comprising:
the light source device according to claim 5;
an imaging element which modulates the white light emitted by the light source device, and outputs the modulated white light as an image; and
a projection lens which projects the image output by the imaging element.
